(19) United States
(12) Patent Application Publication
(10) Pub. No.: US 2014/0281888 A1
(43) Pub. Date: Sep. 18, 2014

(54) Inline Editing of a Displayed Visual Component

(71) Applicant: BAZAARVOICE, INC., Austin, TX (US)

(72) Inventors: Jeff Rego, Austin, TX (US); Michael D. Norman, Austin, TX (US)

(73) Assignee: Bazaarvoice, Inc., Austin, TX (US)

(21) Appl. No.: 13/831,562

(22) Filed: Mar. 14, 2013

(51) Int. Cl. G06F 17/22

(52) U.S. Cl. CPC G06F 17/2247
USPC 715/234

(57) ABSTRACT

A web developer or other user may rapidly update the appearance of user generated content (UGC) or other content that appears as part of a web page. The look and feel of UGC or other content may be customized in order to provider a user of a web site with a better browsing experience, and to make the UGC's appearance consistent with other web site portions. In various embodiments, a displayed preview of content may be updated without having to communicate with an external program and/or without having to re-load a graphical rendering engine that is used to display the content preview. An API may be used to change internal data settings of a graphical rendering engine, which may enable the graphical rendering engine to avoid re-loading data or settings that have not been changed, thus speeding up user interaction.

### BACKGROUND

This disclosure relates to display of content using a graphical rendering engine, and more particularly, to previewing content (such as a portion of a web page), and allowing a user to change the look and feel of such previewed content.

Web pages may include user generated content (UGC) or other content that is received from an outside source (for example, a repository of UGC). Thus, a web site of an entity such as an electronics reseller may include UGC that has been gathered from a number of other sources (e.g., other web sites) and then provided to the electronics reseller (or provided directly to a customer browsing the reseller's web site).

The look and feel (color, font style, etc.) of UGC or other content may be controlled by changing one or more settings. Thus, while an electronics reseller may have particular settings that control the display of UGC, another web site featuring the same or similar UGC may have different settings. An owner of a web site may therefore wish to change look and feel settings so that content such as UGC appears visually attractive.

Changing such display settings can be a time-consuming and tedious process, however. For example, changing a font or image color setting may necessitate re-loading an entire web page to see what effect the change produces. Furthermore, implementing multiple look and feel adjustments may require re-loading a web page several times until a final set of desired changes is achieved. Such re-loading may introduce inefficiency to an editing process.

### BRIEF DESCRIPTION OF THE DRAWINGS

FIG. 1 is a block diagram illustrating one embodiment of a system overview.

FIG. 2A is a block diagram illustrating one embodiment of a graphical editing program and a graphical rendering engine.

FIG. 2B is a related block diagram illustrating the embodiment of FIG. 2A after certain changes have been made.

FIG. 3 is a flow chart of one embodiment of a method relating to displaying a preview of a particular web page and updating the displayed preview in accordance with received user input.

FIG. 4 is a diagram illustrating one embodiment of a computer readable storage medium.

FIG. 5 is a diagram illustrating one embodiment of an exemplary computer system.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

The following paragraphs provide definitions and/or context for terms found in this disclosure (including the appended claims):

“Comprising.” This term is open-ended. As used herein, this term does not foreclose additional structure or steps. Consider a claim that recites: “a system comprising a processor and a memory . . . . ” Such a claim does not foreclose the system from including additional components such as interface circuitry, a graphics processing unit (GPU), etc.

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation(s), etc. Reciting that a unit/circuit/component is “configured to” perform one or more tasks is expressly intended not to invoke 35 U.S.C. §112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue.

“First,” “Second,” etc. As used herein, these terms are used as labels for nouns that they precede unless otherwise noted, and do not imply any type of ordering (e.g., spatial, temporal, logical, etc.). For example, a “first” graphical rendering engine and a “second” graphical rendering engine can be used to refer to any two graphical rendering engines. In other words, “first” and “second” are descriptors.

“Based On” or “Based Upon.” As used herein, these terms are used to describe one or more factors that affect a determination. These terms do not foreclose additional factors that may affect a determination. That is, a determination may be solely based on the factor(s) stated or may be based on one or more factors in addition to the factor(s) stated. Consider the phrase “determining A based on B.” While B may be a factor that affects the determination of A, such a phrase does not foreclose the determination of A from also being based on C. In other instances, however, A may be determined based solely on B.

“Provider.” As used herein, this term includes its ordinary meaning and may refer, in various embodiments, to a manufacturer, offeror of services, restaurant, reseller, retailer, wholesaler, and/or distributor.

“User generated content” (UGC). As used herein, this term refers to text, audio, video, or another information carrying medium that is generated by a user who may be a consumer of something (e.g., of goods, a product, a website, a service), a purchaser of that something, or may otherwise have an interest in that something. User generated content includes, in various embodiments, user reviews, user stories, ratings, comments, problems, issues, questions, answers, opinions, or other types of content.

Structures and techniques are described herein that allow a web developer or other user to rapidly update the appearance of UGC or other content that appears as part of a web page (though the techniques described herein are not limited to web pages). Accordingly, the look and feel of UGC or other content may be customized in order to provide a user of a web site with a better browsing experience, and to make the UGC consistent with other portions of that web site.

In various embodiments, a displayed preview of content may be updated without having to communicate with an external program and/or without having to re-load a graphical rendering engine that is used to display the content preview. An API may be used to change internal data settings of a graphical rendering engine, which may enable the graphical rendering engine to avoid re-loading data or settings that have not been changed, thus speeding up user interaction when designing the look and feel of a web page that includes UGC or other content. Further, even if a graphical rendering engine changes (such as the result of a new software update being published), it may be unnecessary to modify any of the executable files that comprise a graphical editing program that is used in conjunction with the graphical rendering engine.

Turning now to FIG. 1, a block diagram 100 depicting one embodiment of a system overview is shown. In this figure, one or more user computing devices 102 may be in communication with one or more of systems 120 and 130 via a network 114. Network 114 may be the Internet in some embodiments, and may include one or more other networks (not depicted), wired or wireless communication links, etc.

User computing device 102 may be a mobile device, laptop, desktop, or other type of computing system. In various embodiments, user computing device 102 may correspond to one or more aspects of computer system 500 (described below relative to FIG. 5). Likewise, each of systems 120 and 130 may by any type of computing system, and in various embodiments may correspond to one or more aspects of computer system 500. In one embodiment, user computing device 102 is used to browse a website hosted by provider system 120.

Provider system 120 may be any computer system, in various embodiments, that is associated with a provider of goods and/or services. Thus, in some embodiments, provider system 120 is owned or operated by a provider, while in other embodiments, is owned or operated by another party (e.g., a third party having a relationship with the provider). Provider system 120 may include a server that is configured, in various embodiments, to facilitate purchases of goods or services, to provide information (which may include UGC) about goods or services, and/or to solicit UGC relating to an opinion of one or more goods or services. Accordingly, provider system 120 may facilitate the presentation of UGC to a user of computing device 102 in the embodiment of FIG. 1. Furthermore, in some embodiments, provider system 120 is configured to perform functions such as interfacing with delivery systems, payment systems, or other systems.

Content system 130 may, in various embodiments, be configured to receive UGC, store UGC, provide UGC, and/or perform other actions. In some embodiments, content system 130 is configured to receive UGC and/or other information (e.g., transactional details, etc.) from provider system 120, and may be controlled by (or associated with) an entity other than an entity that owns or operates provider system 120. Content system 130 may also receive UGC and/or other data from other systems not depicted (e.g., a system corresponding to an external site such as YELP.COM, GOOGLE.COM, etc.) in some embodiments.

Thus, in various embodiments, content system 130 stores UGC and later provides that UGC to provider system 120 (or provides the UGC directly to a user computing device 102) so that a user of a website can view the provided UGC as part of a browsing experience. UGC that has been provided to a user in this manner may help facilitate a purchase, provide information, and/or perform other functions. UGC that is provided to a user of a website may have a particular look and feel (i.e., aspects of the UGC may be matched to a website on which the UGC appears).

In presenting UGC (or other content) to a user computing device 102, an entity associated with provider system 120 may therefore wish to have some degree of control over the look and feel of the presented UGC. A webmaster or web developer of a website associated with provider system 120, for example, may wish for UGC to be presented according to a certain color scheme or font scheme, or in association with one or more particular graphical images. Presented UGC (or other content) may be formatted according to various different web technologies, and may include (or be included in) HTML, CSS, script (such as JavaScript), or ADOBE FLASH, to cite several non-limiting examples. Accordingly, in some embodiments, UGC may be presented to a user computing device 102 as a seamless part of a particular website, while the website itself may be comprised of files from provider system 120 and/or content (UGC) from content system 130.

Turning now to FIG. 2A, a block diagram 200 of one embodiment of a graphical editing program 205 is shown. As depicted in the embodiment of FIG. 2A, graphical editing program 205 includes selectable editing components 212 (e.g., 212A, 212B) and an instance of a graphical rendering engine 220. In various embodiments, graphical editing program 205 is configured to display a preview of a web page (or other content), e.g., via graphical rendering engine 220. Note that as used herein, the term “displaying a preview of a web page” indicates that a preview is being shown of at least a portion of a web page (that is, in some embodiments, one or more portions of a web page may not be shown in a preview, while in other embodiments, an entire web page may be displayed in the preview.)

Graphical rendering engine 220, in various embodiments, is separately executable from graphical editing program 205. Accordingly, in some embodiments, graphical rendering engine 220 may be developed separately from graphical editing program 205. For example, an embodiment of graphical editing program 205 may be configured to cause display of previews using a loaded instance of graphical rendering engine 220 that corresponds to a third party-supplied industry-standard web browser. In some embodiments, instances of two or more different graphical rendering engines 220 (e.g., corresponding to different web browsers) may be alternately and/or concurrently loaded by graphical editing program 205 to provide rendered previews matching different web browsers. Thus, source code for graphical rendering engine 220 is not required to be part of graphical editing program 205, and these two programs may be separately compiled as two different executables. Nonetheless, in various embodiments, graphical editing program 205 may load one or more instances of graphical rendering engine 220—that is, one or more executable programs (and/or threads) that comprise graphical editing program 205 may call or otherwise cause execution of one or more executable programs (and/or threads) that comprise graphical rendering engine 220. One or more instances of graphical rendering engine 220 may therefore be controlled by graphical editing program 205 in some embodiments.

As shown in the embodiment of FIG. 2A, graphical rendering engine 220 is displaying a preview of a web page that includes user generated content (UGC) 230. In the embodiment shown, UGC 230 includes a “star rating” 232, a user comment 234, and a picture 236 of a product that has been reviewed. The contents of UGC 230 are not thus limited, however, and may include any number of visual, aural, or other components as will be understood by one of ordinary skill in the art.

The look and feel of various aspects of UGC 230 (or other content or portions of a web page) is definable by graphical editing program 205 in various embodiments. Thus, in one embodiment, graphical editing program 205 includes a user selectable component 212A for changing the color, shape, size, pattern, etc., of graphic elements such as stars 232. For example, stars 232 may be shown as being blue, orange, or any color value generally, in various embodiments. Component 212A may also, in some embodiments, change a transparency value of stars 232, change a pattern of stars 232, or otherwise change the size and/or appearance of stars 232. Numerous other editing options may also be available to users via user selectable component 212B for other content aspects.

Turning to FIG. 2B, a block diagram 250 is shown of graphical editing program 205 following changes made from the depiction of graphical edition program 205 in FIG. 2A. In FIG. 2B, for example, the coloring and pattern of stars 232 have been changed using component 212A. The font of user comment 234 has been changed using component 212B, and is now bolded and underlined. The appearance/layout of user comment 234 has also been changed by removing a user ID to which the comment had been previously attributed (i.e., the text “User78746” that previously appeared in FIG. 2A has been removed). Note that for purposes of illustration, UGC 230 is depicted in FIGS. 2A and 2B as being a specific, particular example of submitted UGC. In various embodiments, however, graphical rendering engine 220 may display a template that does not include specific user-submitted data (e.g., the template may indicate what content will look like, but may be based on mock data).

Turning now to FIG. 3, a flow chart of one embodiment of a method 300 is shown. All or a portion of the steps of method 300 may be performed, in one embodiment, by provider system 120. In another embodiment, all or a portion of the steps of method 300 may be performed by another system (e.g., such as user computing device 102).

In step 310, a graphical editing program (e.g., program 205) displays a preview of a particular web page. In one embodiment, this step includes display of a preview of content as discussed above relative to FIG. 2A and/or FIG. 2B. In step 320, a graphical editing program such as program 205 receives user input regarding editing an appearance of one or more aspects of a portion of a particular web page. In one embodiment, step 320 may occur as discussed above relative to FIGS. 2A and/or 2B.

Thus, user input indicative of a changed color or font of a portion of a particular web page may be received at graphical editing program 205 in various embodiments. In some embodiments, user input indicative of a changed layout of content (i.e., positioning or relative positioning of content) may be received by graphical editing program 205. For example, user comment 234 may be moved such that it appears above star rating 232 rather than below it, in one embodiment. Received user input may also be indicative of a graphical image that is displayed as part of a web page. Thus, in some embodiments, a user may add (or remove) a logo, background image, or other image that is displayed in association with UGC 230. In one embodiment, an icon or avatar may be associated with a person who has authored UGC 230, and a graphical image representative of that icon or avatar may be displayed. Such an image may have corresponding settings changed (e.g., making the image size larger or smaller, or repositioning it within a web page). Using some embodiments, a user may redefine or replace various images, such as resizing or altering the shapes of stars 232, or replacing stars 232 with completely different shapes (e.g., a custom image). Received user input is not limited to effecting the changes described above, however, but may be used to alter any aspect of content look and feel in various embodiments.

In various embodiments of step 320, graphical editing program 205 may receive user input regarding editing an appearance of one or more aspects of a portion of a particular web page (or other content). Graphical editing program 205 may furthermore use graphical rendering engine 220 to update a displayed preview of a web page (or other content) in accordance with user input that has been received. Thus, in some cases one or more graphical rendering engines 205 may be selected in order to render a preview that accurately matches display of the particular web page when subsequently rendered by another application, such as a particular browser (e.g., a WEBKIT engine may be used by graphical editing program to preview display corresponding to GOOGLE CHROME, a GECKO engine may be used to preview display corresponding to MOZILLA FIREFOX). By using the same rendering engine as is employed in the application (e.g., browser) that will display the particular web page, various embodiments of graphical editing program 205 may provide a preview that duplicates the display that is presented to an end user, and avoid unexpected problems that may occur due to rendering engine-specific variations. In some embodiments, updating of a displayed preview of a web page is performed by graphical editing program 205 without communicating with a program that is external to graphical editing program 205. (In such embodiments, a program “external” to graphical editing program 205 refers to a program that is not currently running under the control of graphical editing program and that is not a portion of an operating system (OS) being used to run graphical editing program 205. Thus, graphical editing program 205 may pass information to an instance of graphical rendering engine 220 that has previously been loaded by graphical editing program 205, and/or a video graphics driver that is part of the OS, for example, without being said to communicate with an “external” program.)

In one embodiment, updating a displayed preview of a web page (or other content) may be performed by graphical editing program 205 making one or more specific application programming interface (API) function calls to an instance of graphical rendering engine 220. For example, an instance of graphical rendering engine 220 running under control of graphical editing program 205 may maintain one or more internal data structures that are indicative of the look and feel of a web page (or other content) that is being previewed. Thus, in various embodiments, graphical rendering engine 220 may have an internal data setting for the color of stars 232, and other internal data settings for the font size and font type of user comment 234. Many additional data settings may also be present in such an internal data structure of graphical rendering engine 220.

Because data settings maintained by graphical rendering engine 220 may be internal to one or more instances of engine 220, in some embodiments, these settings cannot be directly accessed by separately executable graphical editing program 205. The internal data settings of graphical rendering engine 220 may be exposed to graphical editing program 205 via an API, however. Thus, in one embodiment, graphical editing program 205 may call an API function such as “ChangeStarColor(StartItemName, NewColorValue)”, which results in a color value being passed to graphical rendering engine 220. Graphical rendering engine 220 may thus perform a dynamic update of a color for stars 232 without having to re-load or re-start engine 220 (and a web developer may quickly see the results of such a color update within the same previously running instance of graphical rendering engine 220). Numerous other settings affecting the look and feel of content may also be directly updated in engine 220 via a provided API. Thus, in various embodiments, an API function call into graphical rendering engine 220 (by graphical editing program 205) causes an update of a displayed web page, UGC, and/or other content.

In various embodiments, providing an API that allows internal settings of a loaded instance of graphical rendering engine 220 to be dynamically and selectively changed provides a significant advantage in display update time over the alternative of simply re-loading an entirely new instance of graphical rendering engine 220, or completely refreshing all settings of graphical rendering engine 220. For example, while re-loading a new instance of engine 220 and/or refreshing all settings might cause changed look and feel settings to be reflected in a display of an updated preview, the disadvantage of this approach is that graphical rendering engine 220 may have to read (and then cause display of) content that is reflective of dozens or even hundreds or thousands of different settings, many of which may not actually have been changed by a user (e.g., a web developer). In other words, re-loading graphical rendering engine 220 from scratch and/or refreshing all settings may be excessively slow for providing a good user interaction experience. By instead using an API to effect a change in internal settings of a loaded instance of graphical rendering engine 220, it is possible in some embodiments to change only the particular values that are relevant. This may provide for a better user interaction experience by having a changed value that is reflected in mere milliseconds (e.g., during a routine refresh or frame draw of graphical rendering engine 220), for example, instead of potentially having to wait hundreds of milliseconds (or even longer) as might be required for a complete re-load of graphical rendering engine 220 and/or to perform new rendering calculations for all portions of a display that includes an updated portion. Also note that in some embodiments, look and feel content settings may be stored at content system 130, which may provide pre-processing and/or pre-rendering of UGC or other content. Accordingly, effecting a local change in a copy of settings stored at provider system 120, for example, may also avoid having to make a round trip over network 114 to content system 130, which may also save additional time.

In some embodiments, two or more instances of a graphical rendering engine may be used to display a preview of content. In one embodiment, a first instance of graphical rendering engine 220 and a second instance of graphical rendering engine 220 are therefore used to display a preview of a web page (or other content). A first graphical rendering engine may display content that will appear on one portion of a web page, for example, while a second graphical rendering engine displays content that will appear on a different portion of the web page (i.e., at a different screen location). Again, note that in general, a displayed preview of content (such as content forming a portion of a web page), may be previewed in various embodiments in combination with an entire web page, or may be previewed in isolation from one or more other portions of the web page. That is, in some embodiments, a user of graphical editing program 205 may see a preview of an entire web page, while in other embodiments, a web developer or other user may see only a preview of part, but not all, of a web page.

In embodiments in which multiple instances of a graphical rendering engine are used, the rendering engine instances may be either different from one another or the same type. Thus, in one embodiment, a first instance of a graphical rendering engine may display first particular content using rendering for ADOBE FLASH, while a second instance of a graphical rendering engine may display second particular content using rendering for MOZILLA FIREFOX (e.g., providing a preview of content as presented on FIREFOX, where a portion of the presented page may be rendered using FLASH). In another embodiment, two different instances of a same type of graphical rendering engine may be used to display a preview of different content (e.g., two instances of WEBKIT engines may display first and second content that correspond to different pages on a website, as presented on GOOGLE CHROME), while in yet another embodiment, different types of graphical rendering engine may be used to display a preview of the same or different content (e.g., a first engine may show particular content rendered according to GOOGLE CHROME while a second engine may show the same particular content rendered according to MOZILLA FIREFOX, thereby providing previews of a particular set of user input as would be presented on two different platforms). Note that in various embodiments, a single instance of graphical rendering engine 220 may also be used to render graphical content according to two different technologies.

In another embodiment of method 300, graphical rendering engine 220 is loaded based on a user command. For example, in some embodiments, graphical rendering engine 220 may not be loaded upon initial startup of graphical editing program 205, but may be loaded after a user command (e.g., a command to preview particular content) is received. A user may also select a particular rendering engine from a plurality of different rendering engines in various embodiments. Thus, in accordance with the description above, a user command may cause a selection of one type of engine (e.g., FLASH) or another type of engine (e.g., WEBKIT). In some embodiments, graphical rendering engine 220 may be used to display depiction of three-dimensional content (and thus, three-dimensional shapes may be rendered in various embodiments).

Editing control display functions may be registered by graphical editing program 205 with graphical rendering engine 220 in some embodiments. Because graphical rendering engine 220 may be separately executable from graphical editing program 205, in some cases user editing components 212 may not be directly accessible from within graphical rendering engine 220. Thus, in one embodiment, a portion of a display screen that is controlled by the loaded instance of graphical rendering engine 220 may not be usable to directly provide access to editing functions of program 205. It would be advantageous, however, to allow a user to directly edit (e.g., select, drag, rotate, stretch, etc.) look and feel aspects of displayed content from within an area of a display that is provided by an instance of graphical rendering engine 220, as opposed to a user selecting a component 212 (e.g., from a list or menu) from within graphical editing program 205.

Thus, in one embodiment, graphical editing program 205 is configured to register one or more editing control display functions (such as changing a color of stars 232) with the loaded instance of graphical rendering engine 220. Registration of editing control display functions may be performed via an API into graphical rendering engine 220, in various embodiments (e.g., RegisterEditorOnSelectStar(StarItemName, ActivateEditorFunc). Accordingly, in one embodiment, graphical editing program 205 may pass a function handle to the loaded instance of graphical rendering engine 220, which may cause the function to be called whenever a user right-clicks on an element that is rendered by engine 220 (or takes another input action). Right-clicking on an image for stars 232 (controlled by the loaded instance of graphical rendering engine 220), for example, may cause a color selection popup window (controlled by graphical editing program 205) to be called by graphical rendering engine 220. Based on user input received at the portion of the display provided by the loaded instance of graphical rendering engine 220, graphical editing program 205 may therefore cause one or more editing control display functions (menus, color wheels, etc.) to be opened.

Thus, registering an editing control display function of graphical editing program 205 with graphical rendering engine 220 may provide a better user interaction experience in various embodiments. For example, instead of a user having to make a selection from a distant region of a display device (e.g., making a selection from a menu bar at the top of a screen or from one of selectable components 212), a user may be able to directly click on (or otherwise select) a portion of content that is being directly displayed by the loaded instance of graphical rendering engine 220. While graphical rendering engine 220 might not ordinarily be aware of particular editing functions that are provided by graphical editing program 205, once such functions are registered, the loaded instance of graphical rendering engine 220 can call these functions (as well as passing along any relevant information, such as cursor position, etc.). Accordingly, pop-up windows or other user input mechanisms may be provided by graphical editing program 205 in response to user interaction with elements rendered by the loaded instance of graphical rendering engine 220.

Turning now to FIG. 4, computer readable storage medium 400 is shown. In various embodiments, any or all of the modules (or a portion thereof) in medium 400 can be present in any computer system or computing device described herein (e.g., such as provider system 120). As shown, computer readable storage medium 400 includes a preview display module 410 and a user input module 420. In one embodiment, graphical editing program 205 comprises both module 410 and 420, and in some embodiments, one or more additional modules 430 may also be present, which may be executed to cause additional steps or features to be performed. In general, any steps, details, characteristics, or features described relative to method 300 and/or computer readable medium 400 may be suitably combined as consistent with this disclosure in various embodiments.

As shown, module 410 includes instructions that are executable to cause a computer system to cause display of a preview of particular content using an instance of a graphical rendering engine that was loaded by a graphical editing program executing on the computer system, where the graphical rendering engine is separately executable from the graphical editing program by the computer system. Module 410 may also be executable in various embodiments to cause update the displayed preview of the particular content in accordance with received user input. Thus, module 420 is executable in various embodiments to receive user input regarding editing an appearance of one or more aspects of a portion of particular content (e.g., that is being displayed). Various functionality of modules 410, 420, and 430 may correspond to features described above relative to FIG. 3, in various embodiments.

### Exemplary Computer System

Turning now to FIG. 5, one embodiment of an exemplary computer system 500 is depicted. Computer system 500 includes a processor subsystem 550 that is coupled to a system memory 510 and I/O interfaces(s) 530 via an interconnect 520 (e.g., a system bus). I/O interface(s) 530 are coupled to one or more I/O devices 540. Computer system 500 may be any of various types of devices, including, but not limited to, a server system, personal computer system, desktop computer, laptop or notebook computer, mainframe computer system, handheld computer, workstation, network computer, or a device such as a mobile phone, pager, or personal data assistant (PDA). Computer system 500 may also be any type of networked peripheral device such as storage devices, switches, modems, routers, etc. Although a single computer system 500 is shown for convenience, the system may also be implemented as two or more computer systems operating together.

Processor subsystem 550 may include one or more processors or processing units. In various embodiments of computer system 500, multiple instances of the processor subsystem may be coupled to interconnect 520. In various embodiments, processor subsystem 550 (or each processor unit within the subsystem) may contain a cache or other form of on-board memory. In one embodiment, processor subsystem 550 may include one or more processors.

System memory 510 is usable by processor subsystem 550. System memory 510 may be implemented using different physical memory media, such as hard disk storage, floppy disk storage, removable disk storage, flash memory, random access memory (RAM—SRAM, EDO RAM, SDRAM, DDR SDRAM, RDRAM, etc.), read only memory (PROM, EEPROM, etc.), and so on. Memory in computer system 500 is not limited to primary storage. Rather, computer system 500 may also include other forms of storage such as cache memory in processor subsystem 550 and secondary storage on the I/O Devices 540 (e.g., a hard drive, storage array, etc.). In some embodiments, these other forms of storage may also store program instructions executable by processor subsystem 550.

I/O interfaces 530 may be any of various types of interfaces configured to couple to and communicate with other devices, according to various embodiments. In one embodiment, I/O interface 530 is a bridge chip (e.g., Southbridge) from a front-side to one or more back-side buses. I/O interfaces 530 may be coupled to one or more I/O devices 540 via one or more corresponding buses or other interfaces. Examples of I/O devices 540 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 500 is coupled to a network via a network interface device. The network interface device may be a wireless interface in various embodiments. In other embodiments, computer system 500 is part of a cloud-based computing service. In general, the present disclosure is not limited to any particular type of computer architecture.

### Computer-Readable Medium

The above-described techniques and methods may be implemented as computer-readable instructions stored on any suitable computer-readable storage medium (such as medium 400). As used herein, the term computer-readable storage medium refers to a (nontransitory, tangible) medium that is readable by a computing device or computer system, and includes magnetic, optical, and solid-state storage media such as hard drives, optical disks, DVDs, volatile or nonvolatile RAM devices, holographic storage, programmable memory, etc. The term “non-transitory” as applied to computer-readable media herein is only intended to exclude from claim scope any subject matter that is deemed to be ineligible under 35 U.S.C. §101, such as transitory (intangible) media (e.g., carrier waves per se), and is not intended to exclude any subject matter otherwise considered to be statutory. Computer-readable storage mediums can be used, in various embodiments, to store executable instructions and/or data. In some embodiments, particular functionality may be implemented by one or more software “modules”. A software module may include one or more executable files, web applications, and/or other files, and in some embodiments, and may make use of PHP, JAVASCIPT, HTML, Objective-C, JAVA, or any other suitable technology. In various embodiments, software functionality may be split across one or more modules and/or may be implemented using parallel computing techniques, while in other embodiments various software functionality may be combined in single modules. Software functionality may be implemented and/or stored on two or more computer systems (e.g., a server farm, or a front-end server and a back-end server and/or other computing systems and/or devices) in various embodiments.

### LISTING OF SELECTED EMBODIMENTS

The following embodiment listings are provided in accordance with structures and techniques described herein:

### Embodiment 1

A method, comprising:

a graphical editing program, executing at a computer system, displaying a preview of a particular web page, wherein said displaying is performed using an instance of a graphical rendering engine that was loaded by the graphical editing program, and wherein the graphical rendering engine is separately executable from the graphical editing program by the computer system;

the graphical editing program receiving user input regarding editing an appearance of one or more aspects of a portion of the particular web page; and

the graphical editing program updating the displayed preview in accordance with the received user input, wherein said updating is performed using the instance of the graphical rendering engine, and wherein said updating is performed without communicating with a program that is external to the graphical editing program.

### Embodiment 2

The method of embodiment 1, further comprising the graphical editing program causing one or more internal settings of the instance of the graphical rendering engine to be changed by using the received user input to make one or more specific API function calls to the graphical rendering engine.

### Embodiment 3

The method of embodiment 1, further comprising:

the graphical editing program registering one or more editing control display functions with the instance of the graphical rendering engine;

receiving particular user input at a portion of the display provided by the instance of the graphical rendering engine; and

based on the received particular user input, the instance of the graphical rendering engine causing the graphical editing program to open the one or more editing control display functions.

### Embodiment 4

The method of embodiment 3, wherein the user input regarding editing an appearance of one or more aspects of a portion of the particular web page is received via at least one of the opened one or more editing control display functions.

### Embodiment 5

The method of embodiment 1, further comprising displaying a preview of additional content via a second instance of a different graphical rendering engine that was loaded by the graphical editing program, wherein the different graphical rendering engine is separately executable from the graphical editing program by the computer system.

### Embodiment 6

The method of embodiment 1, wherein the received user input is indicative of a changed color of the portion of the particular web page.

### Embodiment 7

The method of embodiment 1, wherein the received user input is indicative of a changed layout of content of the portion of the particular web page.

### Embodiment 8

The method of embodiment 1, wherein the received user input is indicative of a graphical image displayed in the portion of the particular web page.

### Embodiment 9

The method of embodiment 1, further comprising loading the graphical rendering engine based on a user command.

### Embodiment 10

The method of embodiment 9, wherein the user command is a selection of a particular rendering engine from a plurality of different rendering engines.

### Embodiment 11

A computer-readable storage medium having stored thereon instructions that are executable by a computing device to cause the computing device to perform operations comprising:

causing display of a preview of particular content, wherein said display is performed using an instance of a graphical rendering engine that was loaded by a graphical editing program executing on the computing device, wherein the graphical rendering engine is separately executable from the graphical editing program by the computing device;

the graphical editing program receiving user input regarding editing an appearance of one or more aspects of a portion of the particular content; and

the graphical editing program updating the displayed preview in accordance with the received user input, wherein said updating is performed using the instance of the graphical rendering engine, and wherein said updating is performed without communicating with a program that is external to the graphical editing program.

### Embodiment 12

The computer-readable storage medium of embodiment 11, wherein the preview of the particular content comprises a preview of a web page.

### Embodiment 13

The computer-readable storage medium of embodiment 12, wherein the web page includes one or more depictions of user generated content.

### Embodiment 14

The computer-readable storage medium of embodiment 11, wherein the operations further comprise the graphical editing program using a different rendering engine to display the preview of particular content.

### Embodiment 15

The computer-readable storage medium of embodiment 11, wherein the graphical rendering engine is configured to display depictions of three dimensional content.

### Embodiment 16

A computer system, comprising:

a processor; and

a computer readable storage medium having stored thereon instructions that are executable by the computer system, using the processor, to cause the computer system to perform operations comprising:

receiving user editing input that affects an appearance of one or more aspects of a web page that is being displayed via an instance of a graphical rendering engine running on the computer system, wherein the user editing input is received at a graphical editing program that is also running on the computer system, wherein the instance of the graphical rendering program was loaded by the graphical editing program, and wherein the graphical rendering engine is separately executable from the graphical editing program by the computer system; and

the graphical editing program causing the instance of the graphical rendering engine to update the appearance of the one or more aspects of the web page in accordance with the received user editing input without updating portions of the web page that are not affected by the user editing input.

### Embodiment 17

The computer system of embodiment 16, wherein the operations further comprise an instance of a second graphical rendering engine displaying different content under control of the graphical editing program, wherein the second graphical rendering engine is different from the first graphical rendering engine.

### Embodiment 18

The computer system of embodiment 16, wherein the received user editing input affects at least a color or a font of the web page.

### Embodiment 19

The computer system of embodiment 16, wherein the operations further comprise the graphical editing program causing one or more internal settings of the instance of the graphical rendering engine to be changed by using the received user editing input to make one or more specific API function calls to the instance of the graphical rendering engine.

### Embodiment 20

The computer system of embodiment 16, wherein the operations further comprise:

the graphical editing program registering one or more editing control display functions with the instance of the graphical rendering engine;

receiving particular user input at a portion of the display provided by the instance of the graphical rendering engine; and

based on the received particular user input, the instance of the graphical rendering engine causing the graphical editing program to open the one or more editing control display functions.

Although specific embodiments have been described herein, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure. Additionally, section or heading titles provided above in the detailed description should not be construed as limiting the disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
a graphical editing program, executing at a computer system, displaying a preview of a particular web page, wherein said displaying is performed using an instance of a graphical rendering engine that was loaded by the graphical editing program, and wherein the graphical rendering engine is separately executable from the graphical editing program by the computer system;
the graphical editing program receiving user input regarding editing an appearance of one or more aspects of a portion of the particular web page; and
the graphical editing program updating the displayed preview in accordance with the received user input, wherein said updating is performed using the instance of the graphical rendering engine, and wherein said updating is performed without communicating with a program that is external to the graphical editing program.

2. The method of claim 1, further comprising the graphical editing program causing one or more internal settings of the instance of the graphical rendering engine to be changed by using the received user input to make one or more specific API function calls to the graphical rendering engine.

3. The method of claim 1, further comprising:
the graphical editing program registering one or more editing control display functions with the instance of the graphical rendering engine;
receiving particular user input at a portion of the display provided by the instance of the graphical rendering engine; and
based on the received particular user input, the instance of the graphical rendering engine causing the graphical editing program to open the one or more editing control display functions.

4. The method of claim 3, wherein the user input regarding editing an appearance of one or more aspects of a portion of the particular web page is received via at least one of the opened one or more editing control display functions.

5. The method of claim 1, further comprising displaying a preview of additional content via a second instance of a different graphical rendering engine that was loaded by the graphical editing program, wherein the different graphical rendering engine is separately executable from the graphical editing program by the computer system.

6. The method of claim 1, wherein the received user input is indicative of a changed color of the portion of the particular web page.

7. The method of claim 1, wherein the received user input is indicative of a changed layout of content of the portion of the particular web page.

8. The method of claim 1, wherein the received user input is indicative of a graphical image displayed in the portion of the particular web page.

9. The method of claim 1, further comprising loading the graphical rendering engine based on a user command.

10. The method of claim 9, wherein the user command is a selection of a particular rendering engine from a plurality of different rendering engines.

11. A computer-readable storage medium having stored thereon instructions that are executable by a computing device to cause the computing device to perform operations comprising:
causing display of a preview of particular content, wherein said display is performed using an instance of a graphical rendering engine that was loaded by a graphical editing program executing on the computing device, wherein the graphical rendering engine is separately executable from the graphical editing program by the computing device;
the graphical editing program receiving user input regarding editing an appearance of one or more aspects of a portion of the particular content; and
the graphical editing program updating the displayed preview in accordance with the received user input, wherein said updating is performed using the instance of the graphical rendering engine, and wherein said updating is performed without communicating with a program that is external to the graphical editing program.

12. The computer-readable storage medium of claim 11, wherein the preview of the particular content comprises a preview of a web page.

13. The computer-readable storage medium of claim 12, wherein the web page includes one or more depictions of user generated content.

14. The computer-readable storage medium of claim 11, wherein the operations further comprise the graphical editing program using a different rendering engine to display the preview of particular content.

15. The computer-readable storage medium of claim 11, wherein the graphical rendering engine is configured to display depictions of three dimensional content.

16. A computer system, comprising:
a processor; and
a computer readable storage medium having stored thereon instructions that are executable by the computer system, using the processor, to cause the computer system to perform operations comprising:
receiving user editing input that affects an appearance of one or more aspects of a web page that is being displayed via an instance of a graphical rendering engine running on the computer system, wherein the user editing input is received at a graphical editing program that is also running on the computer system, wherein the instance of the graphical rendering program was loaded by the graphical editing program, and wherein the graphical rendering engine is separately executable from the graphical editing program by the computer system; and
the graphical editing program causing the instance of the graphical rendering engine to update the appearance of the one or more aspects of the web page in accordance with the received user editing input without updating portions of the web page that are not affected by the user editing input.

17. The computer system of claim 16, wherein the operations further comprise an instance of a second graphical rendering engine displaying different content under control of the graphical editing program, wherein the second graphical rendering engine is different from the first graphical rendering engine.

18. The computer system of claim 16, wherein the received user editing input affects at least a color or a font of the web page.

19. The computer system of claim 16, wherein the operations further comprise the graphical editing program causing one or more internal settings of the instance of the graphical rendering engine to be changed by using the received user editing input to make one or more specific API function calls to the instance of the graphical rendering engine.

20. The computer system of claim 16, wherein the operations further comprise:
the graphical editing program registering one or more editing control display functions with the instance of the graphical rendering engine;
receiving particular user input at a portion of the display provided by the instance of the graphical rendering engine; and
based on the received particular user input, the instance of the graphical rendering engine causing the graphical editing program to open the one or more editing control display functions.
